(19) United States
(12) Patent Application Publication
(10) Pub. No.: US 2025/0378316 A1
(43) Pub. Date: Dec. 11, 2025

(54) NEUROMORPHIC METHOD TO OPTIMIZE USER ALLOCATION TO EDGE SERVERS

(71) Applicant: Telefonaktiebolaget LM Ericsson (publ), Stockholm (SE)

(72) Inventors: Kim PETERSSON STEENARI, Stockholm (SE); Ahsan Javed AWAN, Vallentuna (SE)

(73) Assignee: Telefonaktiebolaget LM Ericsson (publ), Stockholm (SE)

(21) Appl. No.: 19/107,570

(22) PCT Filed: Sep. 9, 2022
(86) PCT No.: PCT/IB2022/058529

§ 371 Date: Feb. 27, 2025

(51) Int. Cl. G06N 3/063

(52) U.S. Cl. CPC G06N 3/063

(57) ABSTRACT

A method is performed by an electronic device for performing edge user allocation. The method includes selecting a first edge server to connect with a first mobile device. Neurons are arranged as a plurality of winner-take-all neuronal groups, each corresponding to a respective mobile device and comprising a respective first set of neurons representing a plurality of edge servers. Activating a first neuron causes an excitatory signal to be transmitted on a first synapse to a first threshold neuron. Each threshold neuron comprises a plurality of inputs connected by respective first synapses to a respective second set of those neurons of the first sets that correspond to a respective edge server. Each first synapse has a respective weight corresponding to a resource requirement of the mobile device. Activation of the first threshold neuron causes inhibitory signal(s) to be transmitted to at least one other neuron of the respective second set.

### TECHNICAL FIELD

Embodiments of the invention relate to the field of neuromorphic computing; and more specifically, the application of neuromorphic computing techniques to optimize user allocation to edge servers.

### BACKGROUND ART

Cellular telecommunication networks, sometimes referred to herein as “mobile networks,” are relatively large networks encompassing a large number of electronic devices to enable other electronic devices (sometimes referred to as “user equipment” (UE) or “mobile devices”) to connect wirelessly to the mobile network. The mobile network is also typically connected to one or more other networks (e.g., the Internet). The mobile network enables the electronic devices currently connected to the mobile network to communicate over the network(s) with other electronic devices. The mobile network is designed to allow the mobile devices, e.g., mobile phones, tablets, laptops, IoT devices and similar devices, to shift connection points with the mobile network in a manner that maintains continuous connections for the applications of the mobile devices. Typically, the mobile devices connect to the mobile network via radio access network (RAN) base stations (sometimes referred to as “access points”), which provide connectivity to a number of mobile devices for a local area or “cell”. Managing and configuring the mobile network including the cells of the mobile network is an administrative challenge as each cell can have different geographic and/or technological characteristics.

To accommodate the ever-increasing resource demand by the mobile devices, due to the proliferation of mobile devices and as newer computationally-intensive applications are developed (e.g., artificial reality, immersive gaming, digital health care system), computing may be offloaded from the mobile devices generally having limited computing resources onto electronic devices of the mobile network having greater computing resources. For example, the mobile devices request different computation tasks requiring some specified amount of resources to be executed on any suitable electronic device(s). In some cases, the electronic devices that are used to perform the offloaded computation tasks may operate as ingress and/or egress points for the mobile network (e.g., “edge network devices” (edge NDs) or “edge servers”). Thus, the electronic devices encompassed in a mobile network can be of different types and/or perform different functions. For instance, the types and/or functions may include RAN base stations, edge servers, and various others.

During operation, each mobile device is typically within the coverage area(s) of one or more RAN base stations, and each RAN base station may be connected to, and associated with, one or more edge network devices. Allocation determinations may be made at various times to allocate particular edge network device(s) to fulfill the computing requirements of the mobile devices. For example, when a mobile device first connects to a particular RAN base station (e.g., when first connecting to the mobile network) an allocation determination may be made. Similarly, when the mobile device moves between the coverage areas of RAN base stations, an allocation determination may be made to maintain the existing allocation or to allocate other edge network device(s). These allocation determinations may be made according to one or more criteria associated with the mobile network (e.g., supporting a number of connections to mobile devices, maximizing computational throughput, minimizing energy expense, and so forth).

The problem of determining which mobile device(s) should connect to which edge network device(s) to maximize the computational throughput (e.g., number of processed tasks) of the mobile network is called an Edge User Allocation (EUA) problem. The EUA problem may generally be formulated as a variable-sized vector bin packing problem. Current techniques of finding a solution to the EUA problem generally rely on heuristic algorithms but may be suboptimal and/or slow, which consumes excess energy and is not suitable for a dynamic environment (e.g., where mobile devices are expected to move regularly through the coverage areas of different RAN base stations). While quantum techniques can accelerate the time to reaching a solution, such an approach remains energy expensive. Further, the various techniques of solving the EUA problem do not scale well with the size of the problem.

### SUMMARY

In one embodiment, a method is performed by an electronic device for performing edge user allocation for a plurality of mobile devices connected to a mobile network. The method includes selecting a first edge server of a plurality of edge servers of the mobile network to connect with a first mobile device of the plurality of mobile devices. Selecting the first edge server causes a first neuron of a plurality of neurons to be activated. The plurality of neurons are arranged as a plurality of winner-take-all neuronal groups. Each winner-take-all neuronal group corresponds to a respective mobile device of the plurality of mobile devices and comprises a respective first set of the plurality of neurons that represents the plurality of edge servers. The first neuron represents the first edge server in the first set. The method further includes causing, responsive to activating the first neuron, an excitatory signal to be transmitted on a first synapse to a first threshold neuron of a plurality of threshold neurons. Each threshold neuron comprises a plurality of inputs connected by respective first synapses to a respective second set of those neurons of the first sets that correspond to a respective edge server of the plurality of edge servers. Each first synapse has a respective weight corresponding to a resource requirement of the mobile device corresponding to the connected server neuron of the second set. The method further includes, responsive to the excitatory signal causing the first threshold neuron to activate, causing at least one inhibitory signal to be transmitted from the first threshold neuron to at least one other neuron of the respective second set.

In one embodiment, an electronic device is provided that includes a machine-readable medium comprising computer program code for an edge user allocation service to perform edge user allocation for a plurality of mobile device connected to a mobile network. The electronic device further comprises one or more processors to execute the edge user allocation service to cause the electronic device to implement a plurality of neurons arranged as a plurality of winner-take-all neuronal groups. Each winner-take-all neuronal group corresponds to a respective mobile device of the plurality of mobile devices, and comprises a respective first set of the plurality of neurons that represents the plurality of edge servers. The electronic device further implements a plurality of threshold neurons. Each threshold neuron includes a plurality of inputs connected by first synapses to a respective second set of those neurons of the first sets that correspond to a respective edge server of the plurality of edge servers. Each first synapse has a respective weight corresponding to a resource requirement of the mobile device corresponding to the connected server neuron of the second set. Each threshold neuron includes one or more outputs connected by one or more second, inhibitory synapses to one or more neurons of the respective second set.

### BRIEF DESCRIPTION OF THE DRAWINGS

The invention may best be understood by referring to the following description and accompanying drawings that are used to illustrate embodiments of the invention. In the drawings:

FIG. 1 illustrates a method of edge user allocation for a plurality of mobile devices connected to a mobile network, according to one or more embodiments.

FIG. 2 is a diagram illustrating an electronic device including an edge user allocation service, according to one or more embodiments.

FIG. 3 illustrates a method of determining an edge user allocation having a relatively small number of edge servers, according to one or more embodiments.

FIG. 4 is a diagram illustrating connection of a single threshold neuron with a plurality of neurons representing edge servers, according to one or more embodiments.

FIG. 5 is a diagram illustrating synapses connecting pairs of a plurality of neurons representing edge servers, according to one or more embodiments.

FIG. 6A is a diagram illustrating an exemplary implementation of a system for edge user allocation, according to one or more embodiments.

FIG. 6B is a diagram illustrating an exemplary implementation of a system for edge user allocation, according to one or more embodiments.

FIG. 7 is a diagram illustrating inhibitory synapses from a neuron representing an edge server having a greater resource capacity than other edge servers represented by other neurons of a first set, according to one or more embodiments.

FIG. 8 is a diagram illustrating exemplary neuromorphic hardware, according to one or more embodiments.

FIG. 9A illustrates connectivity between network devices (NDs) within an exemplary network, as well as three exemplary implementations of the NDs, according to some embodiments of the invention.

FIG. 9B illustrates an exemplary way to implement a special-purpose network device according to some embodiments of the invention.

FIG. 9C illustrates various exemplary ways in which virtual network elements (VNEs) may be coupled according to some embodiments of the invention.

FIG. 9D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 9E illustrates the simple case of where each of the NDs implements a single NE, but a centralized control plane has abstracted multiple of the NEs in different NDs into (to represent) a single NE in one of the virtual network(s), according to some embodiments of the invention.

FIG. 9F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 10 illustrates a general purpose control plane device with centralized control plane (CCP) software 1050), according to some embodiments of the invention.

FIG. 11 illustrates application of the neural network-based implementations to an example allocation scenario, according to one or more embodiments.

### DETAILED DESCRIPTION

The following description describes methods and apparatus for edge user allocation for a plurality of mobile devices connected to a mobile network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

In some embodiments, edge user allocation is performed using a neural network architecture to manage current allocations of a plurality of mobile devices, which are connected to a mobile network via access points (e.g., RAN base stations) that are part of the mobile network, to a plurality of edge servers that are part of the mobile network and associated with different ones of the access points. The neural network architecture comprises a plurality of neurons arranged as a plurality of winner-take-all neuronal groups. Each winner-take-all neuronal group corresponds to a respective mobile device of the plurality of mobile devices, and comprises a respective first set of the plurality of neurons that represents the plurality of edge servers. The embodiments described herein offer a number of advantages for performing operations for edge user allocation. The improvements in energy efficiency may be two-fold. First, use of the neural network architecture allows the solutions to be more quickly approximated, and the solutions may also be closer to optimal than solutions generated using conventional techniques (e.g., heuristic algorithms). Reaching solutions more quickly tends to reduce the energy expense associated with determining the solutions, and the more optimized solutions generally require fewer edge servers and/or a greater utilization of the edge servers to support a given set of mobile devices, which reduces the energy expense of implementing the solution. Second, some embodiments use neuromorphic hardware to implement the neural network architecture. The neuromorphic hardware is substantially more energy efficient than conventional processor architectures, generally through massive parallelism, co-location of processing and memory at the neurons and synapses, inherent scalability, temporally sparse event-driven computation, and stochasticity.

In one embodiment, a method is performed by an electronic device for performing edge user allocation for a plurality of mobile device connected to a mobile network. The method includes selecting a first edge server of a plurality of edge servers of the mobile network to connect with a first mobile device of the plurality of mobile devices. Selecting the first edge server causes a first neuron of a plurality of neurons to be activated. The plurality of neurons are arranged as a plurality of winner-take-all neuronal groups. Each winner-take-all neuronal group corresponds to a respective mobile device of the plurality of mobile devices and comprises a respective first set of the plurality of neurons that represents the plurality of edge servers. The first neuron represents the first edge server in the first set. The method further includes causing, responsive to the first neuron being activated, an excitatory signal to be transmitted on a first synapse to a first threshold neuron of a plurality of threshold neurons. Each threshold neuron comprises a plurality of inputs connected by respective first synapses to a respective second set of those neurons of the first sets that correspond to a respective edge server of the plurality of edge servers. Each first synapse has a respective weight corresponding to a resource requirement of the mobile device corresponding to the connected neuron of the second set. The method further includes, responsive to the excitatory signal causing the first threshold neuron to activate, causing at least one inhibitory signal to be transmitted from the first threshold neuron to at least one other neuron of the respective second set.

In one embodiment, an electronic device is provided that includes a machine-readable medium comprising computer program code for an edge user allocation service to perform edge user allocation for a plurality of mobile devices connected to a mobile network. The electronic device further includes one or more processors to execute the edge user allocation service to cause the electronic device to implement a plurality of neurons arranged as a plurality of winner-take-all neuronal groups. Each winner-take-all neuronal group corresponds to a respective mobile device of the plurality of mobile devices, and comprises a respective first set of the plurality of neurons that represents the plurality of edge servers. The electronic device further implements a plurality of threshold neurons. Each threshold neuron includes a plurality of inputs connected by first synapses to a respective second set of those neurons of the first sets that correspond to a respective edge server of the plurality of edge servers. Each first synapse has a respective weight corresponding to a resource requirement of the mobile device corresponding to the connected neuron of the second set. Each threshold neuron includes one or more outputs connected by one or more second, inhibitory synapses to one or more neurons of the respective second set.

Current techniques of finding a solution to the edge user allocation problem are generally not suitable for a dynamic environment, as the heuristic algorithms may be unsuitably slow when reaching their solutions. Further, the various techniques of solving the edge user allocation problem do not scale well with increased sizes of the problem (e.g., as more edge servers and/or more mobile devices are added to the mobile network). The neural network architecture described herein uses numerous neurons operating in parallel, and is readily scaled with increases to the problem size. Because the neural network approximates a solution to the optimization problem and its constraints, instead of performing a direct calculation of the solution, the neural network is capable of providing an approximated solution within a suitable amount of time, which allows the neural network to be suitably responsive when applied in dynamic settings.

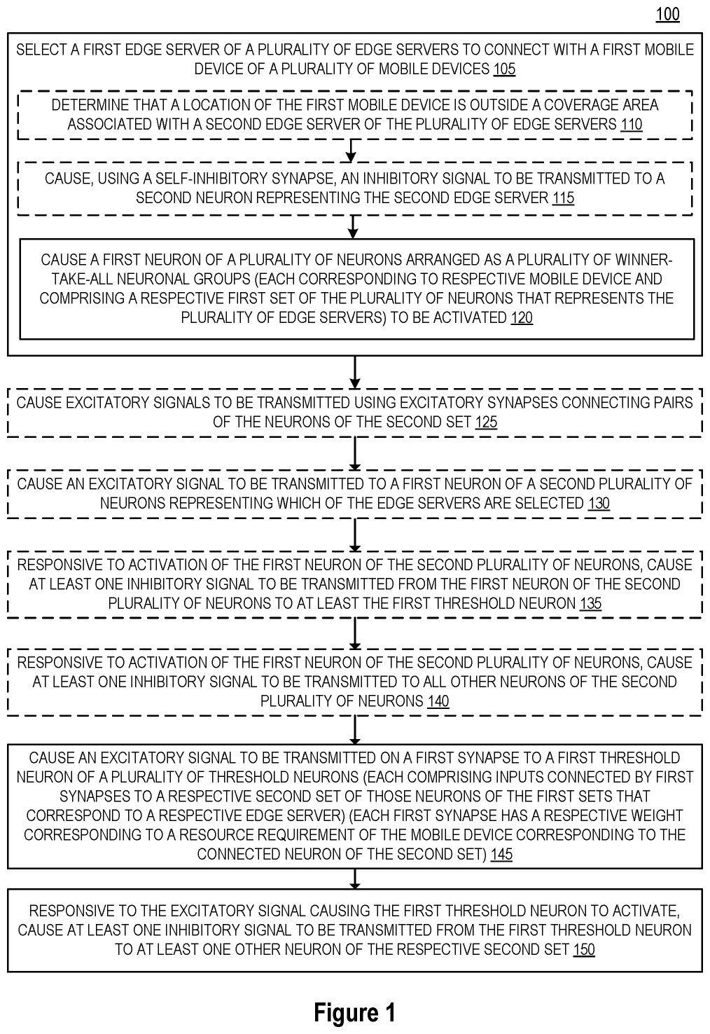

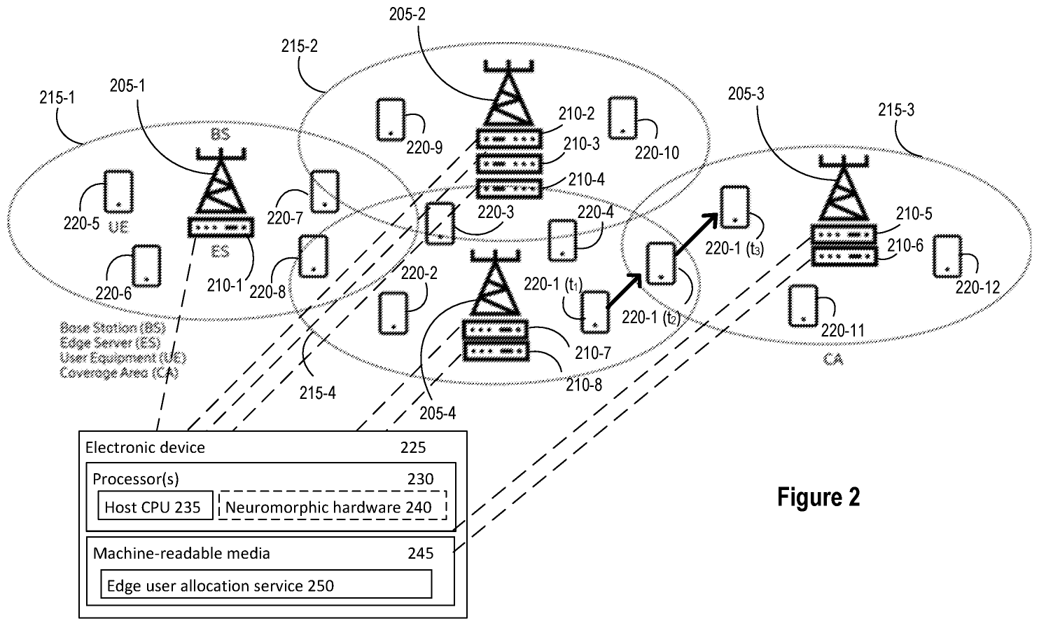

FIG. 1 illustrates a method 100 of edge user allocation for a plurality of mobile devices connected to a mobile network, according to one or more embodiments. The method 100 may be used in conjunction with other embodiments, e.g., performed by a neural network implemented using hardware and/or software of an electronic device 225 shown in the mobile network 200 of FIG. 2. Thus, while various blocks of the method 100 are described as being performed by the electronic device 225, the blocks (or portions thereof) will be understood as being implemented using software executing on hardware (and in some embodiments, in conjunction with specialized hardware such as neuromorphic hardware 240) of the electronic device 225. Further, terms such as “inhibitory signals” and “excitatory signals” will be understood to encompass physical signals that are transmitted using machine-readable transmission media (e.g., wireline electrical signals, wireless signals, optical signals), as well as signals that are simulated in software (e.g., time-based changes in memory states). In some implementations, the method 100 may be used to determine an “optimized” edge user allocation of the plurality of mobile devices without requiring the configuration of the mobile network 200. In other implementations, the method 100 may be used in conjunction with the configuration of the mobile network 200 by the electronic device 225.

As used herein, an electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors each having one or more processor cores (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

The method 100 will be described with reference to the mobile network 200, which illustrates the electronic device 225 including an edge user allocation service 250. The mobile network 200 is depicted in a simplified form for the sake of illustration. The person of ordinary skill in the art will appreciate that the mobile network 200 may include numerous additional electronic devices, functions, and components that would be involved in the operation of the mobile network 200. The mobile network 200 can implement any communication technology such as 3G, 4G, 5G (e.g., as defined by 3GPP) technologies or similar technologies.

The mobile network 200 comprises a plurality of edge servers 210-1, 210-2, . . . , 210-8 (generically or collectively, edge server(s) 210). Each of the edge servers 210-1, 210-2, . . . , 210-8 may be implemented using any type or combination of electronic device(s) that provide computing resources at, or in combination with, access points to the mobile network 200 such as a respective RAN base station 205-1, 205-2, 205-3, 205-4 (also referred to as “base stations”) of the mobile network 200. The edge servers 210-1, 210-2, . . . , 210-8, the base stations 205-1, 205-2, 205-3, 205-4, and/or other electronic devices, functions, and components of the RAN can enable wireless connections with a number of mobile devices 220-1, 220-2, . . . , 220-12 (generically or collectively, mobile device(s) 220) that use the services of the mobile network 200.

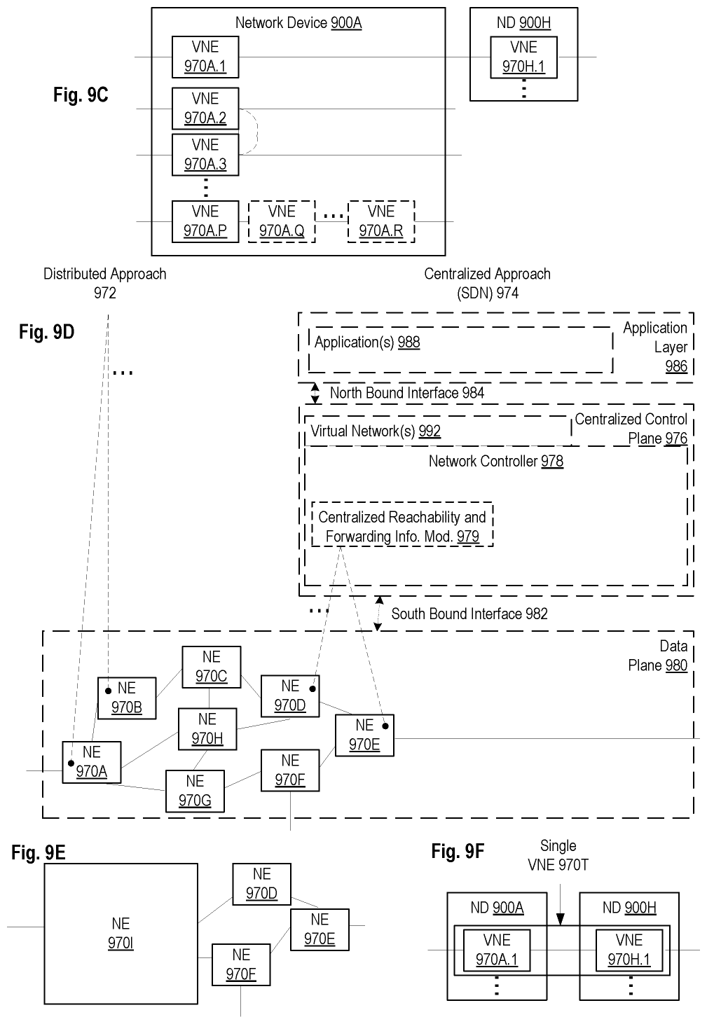

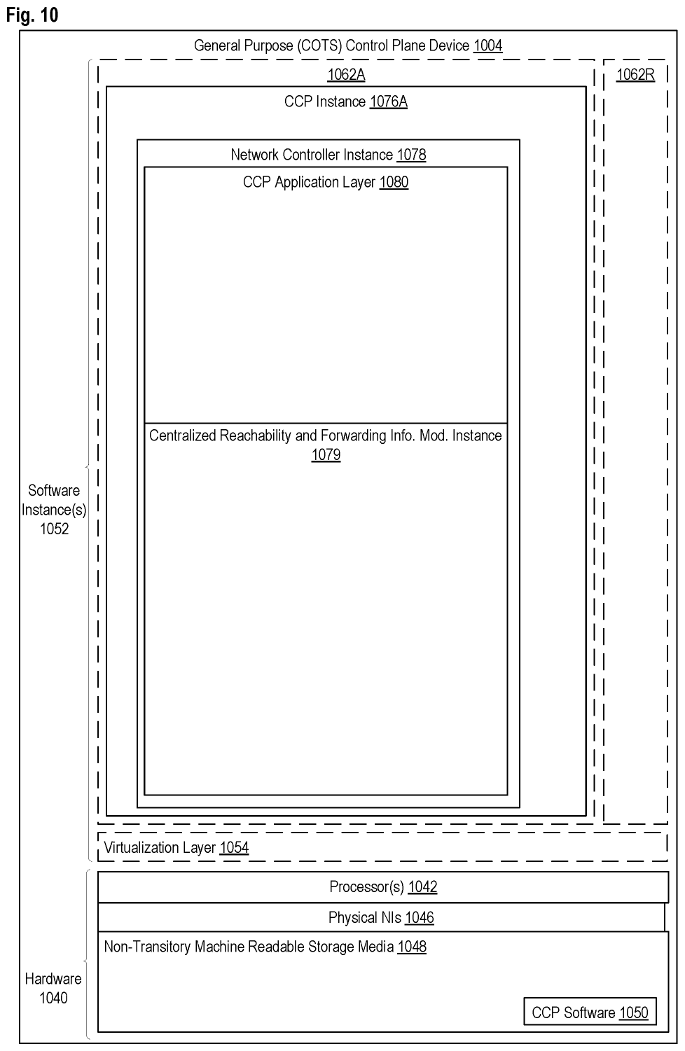

The edge servers 210-1, . . . , 210-8 are implemented using one or more electronic devices of the mobile network 200. In some embodiments, the electronic device(s) are implemented as dedicated edge server(s) 210. In some embodiments, the electronic device(s) provide the edge server(s) 210 as services (e.g., implemented as virtual network elements). Additional implementation details are discussed below with respect to FIGS. 9A-9F and 10. As shown in the mobile network 200, the edge server 210-1 is connected to the base station 205-1 having a coverage area 215-1. The edge servers 210-2, 210-3, 210-4 are connected to the base station 205-2 having a coverage area 215-2. The edge servers 210-5, 210-6 are connected to the base station 205-3 having a coverage area 215-3. The edge servers 210-7, 210-8 are connected to the base station 205-4 having a coverage area 215-4. Based on the relative locations and the operational characteristics of the base stations 205-1, 205-2, 205-3, 205-4, the coverage areas 215-1, 215-2, 215-3, 215-4 (generically or collectively, coverage area(s) 215) are arranged to have some overlap with each other.

The mobile devices 220 as shown are distributed within the coverage areas 215-1, 215-2, 215-3, 215-4. As the mobile devices 220 are mobile in nature, the mobile devices 220 are expected to transit various ones of the coverage areas 215-1, 215-2, 215-3, 215-4. Further, the mobile devices 220 at times may be within coverage area(s) 215 associated with multiple ones of the edge servers 210-1, . . . , 210-8 at a given time (e.g., within a single coverage area 215-1, 215-2, . . . , 215-4 that is associated with multiple edge servers 210-1, . . . , 210-8, or located in an overlapping region of the coverage areas 215-1, 215-2, 215-3, 215-4). For example, a first mobile device 220-1 at a first time t₁ is within the coverage area 215-4, and travels such that the first mobile device 220-1 is in overlapping coverage areas 215-3, 215-4 at a second time t₂, and in the coverage area 215-3 at a third time t₃.

As discussed above, the problem of determining which mobile device 220 should connect to which edge server 210-1, . . . , 210-8 to attempt to maximize the overall computational throughput of the mobile network 200 (e.g., a number of processed tasks) is called an Edge User Allocation (EUA) problem. The EUA problem may generally be formulated as a variable-sized vector bin packing problem. Current techniques of finding a solution to the EUA problem generally rely on heuristic algorithms but may be suboptimal and/or slow, consume excess energy and not be suitable for a dynamic environment (e.g., where mobile devices 220 are expected to move regularly through the coverage areas 215-1, 215-2, . . . , 215-4). While quantum techniques can accelerate the time to reaching a solution to the EUA problem, such an approach remains energy expensive. Further, the various techniques of solving the EUA problem do not scale well with increased sizes of the problem (e.g., more edge servers 210-1, . . . , 210-8 and/or more mobile devices 220).

As discussed herein, the EUA problem may be defined as follows: given m edge servers 210 (represented as S={s₁, s₂, . . . , sᵢ, . . . , sₘ}), n mobile devices (mobile devices 220; represented as U={u₁, u₂, . . . , uⱼ, . . . , uₙ}), and d types of computing resources (e.g., RAM, bandwidth, number of CPU cores, and so forth). Each edge server 210 has some maximum capacity for each resource type

$${C}_{i} = 〈 {C}_{i}^{1} , … , {C}_{i}^{d} 〉$$

and each mobile device 220 some resource requirements for each resource type

$${w}_{i} = 〈 {w}_{j}^{1} , … , {w}_{j}^{d} 〉 .$$

Furthermore, each edge server 210 corresponds to a given coverage area 215 denoted by cov(sᵢ) and each mobile device 220 has a coordinate defined by the distance to each edge server 210 denoted by dᵢⱼ. The objective of the EUA problem is to assign as many of the mobile devices 220 as possible to the edge servers 210, while minimizing the number of utilized edge servers 210 and satisfying three constraints:
(1) Each edge server 210 can be assigned an additional mobile device 220 only where the total resource requirements of the assigned mobile devices 220 do not exceed the maximum capacity of the edge server 210 for any resource type, represented as

$${\sum }_{uj ∈ U ( {s}_{i} )} {w}_{j}^{k} \leq {C}_{i}^{k} , ∀ {s}_{i} ∈ S , ∀ k ∈ \{ 1 , … , d \} .$$

(2) Each mobile device 220 can be connected to at most one edge server 210.
(3) Each mobile device 220 (uⱼ) assigned to an edge server 210 (sᵢ) must be in the coverage area associated with the edge server 210, represented as dᵢⱼ<cov(sᵢ).

A binary variable xᵢⱼ represents whether mobile device 220 (uⱼ) is connected to edge server 210 (sᵢ), and a binary variable yᵢ represents whether the edge server 210 (sᵢ) is utilized or not. Thus, the objective function may be represented as follows:

$$minimize - {\sum }_{j = 1}^{n} {\sum }_{i = 1}^{m} {x}_{ij} + {\sum }_{i = 1}^{m} {y}_{i} ,$$

subject to the constraints:

$${\sum }_{j = 1}^{m} {x}_{ij} {w}_{j}^{k} \leq {C}_{i}^{k} {y}_{i} , ∀ i ∈ \{ 1 , … , m \} , ∀ k ∈ \{ 1 , … , d \} ,$$

$${\sum }_{j = 1}^{m} {x}_{ij} \leq 1 , ∀ i ∈ \{ 1 , … , m \} ,$$

$${d}_{ij} < cov ( {s}_{i} ) , ∀ i ∈ \{ 1 , … , m \} , ∀ j ∈ \{ 1 , … , n \} .$$

In some embodiments, the electronic device 225 implements a neural network operable to solve the objective function. As previously described, while electronic devices may include a number of components, FIG. 2 shows the electronic device 225 as comprising one or more processors 230 and machine-readable media 245 for simplicity. While depicted as a single element within the electronic device 225, the one or more processors 230 contemplates a single processor, multiple processors, a processor or processors having multiple cores, as well as combinations thereof. In one embodiment, the one or more processors 230 comprises a host central processing unit (CPU) 235 of the electronic device 225.

As previously described, machine-readable media, such as machine-readable media 245, may include a variety of media selected for relative performance or other capabilities: volatile and/or non-volatile media, removable and/or non-removable media, etc. Thus, the machine-readable media 245 may include cache, random access memory (RAM), storage, etc. Storage included in the machine-readable media 245 typically provides a non-volatile memory for the electronic device 225, and may include one or more different storage elements such as Flash memory, a hard disk drive, a solid state drive, an optical storage device, and/or a magnetic storage device.

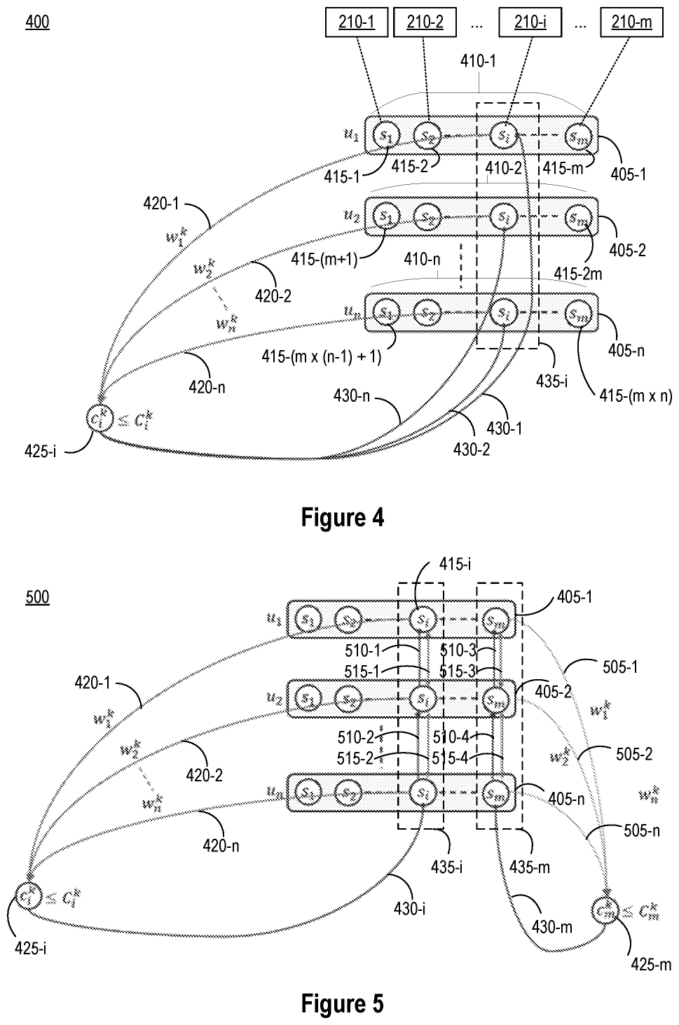

The one or more processors 230 implement, as part of a neural network (such as neural network 400 of FIG. 4), a plurality of neurons 415-1, 415-2, . . . , 415-m, 415-(m+1), . . . , 415-2m, 415-(m×(n−1)+1), . . . , 415-(m×n) (generically or collectively, neuron(s) 415). In some embodiments, each neuron 415 comprises a spiking neuron. The plurality of neurons 415 are arranged as a plurality of winner-take-all neuronal groups 405-1, 405-2, . . . , 405-n. Each winner-take-all neuronal group 405-1, 405-2, . . . , 405-n corresponds to a respective mobile device 220 (u₁, u₂, . . . , uₙ). Each winner-take-all neuronal group 405-1, 405-2, . . . , 405-n comprises a respective first set 410-1, 410-2, . . . , 410-n of the plurality of neurons 415. Each first set 410-1, 410-2, . . . , 410-n represents the plurality of edge servers 210-1, 210-2, . . . , 210-i, . . . , 210-m. As shown, the first set 410-1 comprises m neurons 415-1, 415-2, . . . , 415-m, the first set 410-2 comprises m neurons 415-(m+1), . . . , 415-2m, and the first set 410-n comprises m neurons 415-(m×(n−1)+1), . . . , 415-(m×n).

In each of the winner-take-all neuronal groups 405-1, 405-2, . . . , 405-n, only one neuron 415 spikes at a given time, corresponding to a lowest energy state of the winner-take-all neuronal group 405-1, 405-2, . . . , 405-n. In some embodiments, the neural network 400 further comprises an auxiliary neuron (not shown) within each winner-take-all neuronal groups 405-1, 405-2, . . . , 405-n. The auxiliary neuron connects to all of the neurons 415 within the particular winner-take-all neuronal group 405-1, 405-2, . . . , 405-n. If one neuron 415 is activated, the auxiliary neuron inhibits the other neurons 415 of the winner-take-all neuronal group 405-1, 405-2, . . . , 405-n. If no neurons 415 are activated, the auxiliary neuron may encourage spiking by exciting (potentiating) the neurons 415. The winner-take-all neuronal groups 405-1, 405-2, . . . , 405-n tend to be useful for representing variables, as the winner-take-all neuronal groups 405-1, 405-2, . . . , 405-n encode the allocation of one mobile device 220 (u₁, u₂, . . . , uₙ) to each edge server 210-1, 210-2, . . . , 210-m.

The one or more processors 230 further implement, as part of the neural network, a plurality of threshold neurons (a single threshold neuron 425-i is illustrated for simplicity of illustration in FIG. 4). In some embodiments, each threshold neuron 425 comprises a spiking neuron. Each threshold neuron 425-i comprises a plurality of inputs that are connected by first synapses 420-1, 420-2, . . . , 420-n to a respective second set of those neurons 415 of the first sets 410-1, 410-2, . . . , 410-n that correspond to a respective edge server 210-1, 210-2, . . . , 210-i, . . . 210-m of the plurality of edge servers. For example, the second set 435-i includes the neurons 415 corresponding to the respective edge server 210-i. Each first synapse 420-1, 420-2, . . . , 420-n has a respective weight

$${w}_{1}^{k} , {w}_{2}^{k} , … , {w}_{n}^{k}$$

that corresponds to a resource requirement (of the k^{th} type) of the mobile device 220 (u₁, u₂, . . . , uₙ) corresponding to the connected neuron 415 of the second set 435. Each threshold neuron 425-i further comprises one or more outputs that are connected by one or more second, inhibitory synapses 430-1, 430-2, . . . , 430-n to one or more neurons 415 of the respective second set 435.

The machine-readable media 245 stores an edge user allocation service 250 representing code that is executed by the one or more processors 230 to implement various functionality described herein. In some embodiments, the edge user allocation service 250 operates to simulate the various neurons and synapses of the neural network 400. In some embodiments, the one or more processors 230 comprises neuromorphic hardware 240 that is connected with the host CPU 235. The neuromorphic hardware 240 includes circuitry that mimics neuro-biological architectures of a nervous system, e.g., arranged as neurons and synapses. Some non-limiting examples of the neuromorphic hardware 240 include the TrueNorth integrated circuit (produced by IBM), the Loihi integrated circuit (produced by Intel), the SpiNNaker supercomputer architecture (developed by the University of Manchester), as well as other standardized or proprietary neuromorphic designs. In this case, the edge user allocation service 250 may be executed by the host CPU 235 to configure and/or operate the neuromorphic hardware 240 to implement the various neurons and synapses of the neural network 400.

The use of the neural network 400 to solve the objective function of the EUA problem can provide a number of benefits. For example, the neural network 400 provides a more energy efficient approach when compared to conventional computational techniques (e.g., applying heuristics) for solving the EUA problem. Such energy savings are even more pronounced for those implementations of the electronic device 225 using the neuromorphic hardware 240 to implement the neural network 400.

Further, the electronic device 225 may be capable of operating numerous neurons in parallel with each other (e.g., thousands or millions of neurons, or more), which allows the neural network 400 to be scaled with increases in the problem size (e.g., as more edge servers 210-1, . . . , 210-8 and/or more UE 220 are included in the mobile network 200). Still further, the neural network 400 approximates a solution to the optimization problem and its constraints through the potentiation and inhibition of neurons, instead of through a direct calculation of the solution. Thus, the neural network 400 is capable of providing an approximated solution within a suitable amount of time, which allows the neural network 400 to be suitably responsive to be applied in the dynamic setting (e.g., managing allocation of the UE 220 within the mobile network 200).

Returning to FIG. 1, the method 100 begins at block 105, where the electronic device 225 selects a first edge server 210 of the plurality of edge servers to connect with a first mobile device of the plurality of mobile devices u₁, u₂, . . . , uₙ.

In some embodiments, selecting the first edge server 210 comprises, at optional block 110, determining that a location of the first mobile device is outside a coverage area 215 associated with a second edge server 210 of the plurality of edge servers. For example, location information (such as Global Positioning System (GPS) coordinates) from the various mobile devices 220 may be received by the electronic device 225, which generates a matrix of distances from each mobile device 220 to each edge server 210. The matrix is then used to identify combinations of the mobile devices 220 and the edge servers 210 (e.g., including the second edge server 210 and the mobile device 220 for the first user) to be excluded (in other words, combinations that will not be considered) when determining the solution. While described in terms of distances and the coverage areas 215, alternate implementations may exclude combinations of the mobile devices 220 and the edge servers 210 according to one or more other criteria (e.g., less than a threshold signal strength).

At optional block 115, the electronic device 225 causes, using a self-inhibitory synapse, an inhibitory signal to be transmitted to a second neuron 415 representing the second edge server 210 in the first set 410. Thus, the operations described in the optional blocks 110, 115 may be considered a preprocessing of the plurality of neurons 415 of the first sets 410. Stated another way, and referencing the objective function and constraints described above, when the distance dᵢⱼ from the mobile device 220 (uⱼ) is greater than the coverage area cov(sᵢ) for the given edge server sᵢ, the corresponding neuron sᵢ in the winner-take-all neuronal group 405 for the mobile device 220 (uⱼ) is fully inhibited, meaning that the neuron sᵢ will not impact the solution. Thus, the winner-take-all neuronal group 405 will operate only on a subset of “active” neurons 415, representing those edge servers 210 whose respective coverage areas 215 include the user uⱼ. The preprocessing of the plurality of neurons 415 may greatly reduce the amount of neurons 415 that are considered, which reduces computational expense and/or a time required to reach a solution while satisfying the coverage area-related constraint.

In some embodiments, selecting the first edge server 210 comprises at block 120 activating a first neuron 415 of a plurality of neurons that are arranged as a plurality of winner-take-all neuronal groups 405. As discussed above, each winner-take-all neuronal group 405 corresponds to a respective mobile device of the plurality of mobile devices u₁, u₂, . . . , uₙ, and comprises a respective first set 410 of the plurality of neurons 415 that represents the plurality of edge servers 210. The first neuron 415 represents the first edge server 210 in the first set 410. In some embodiments, activating the first neuron 415 further comprises deactivating all of the other neurons 415 of the particular winner-take-all neuronal group 405.

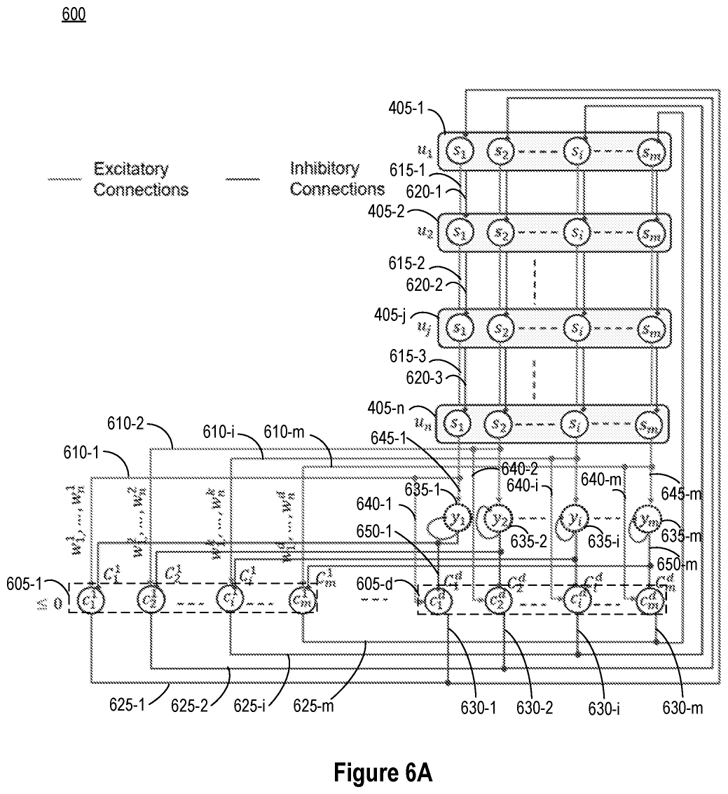

At optional block 125, the electronic device 225 causes, responsive to activating the first neuron 415, excitatory signals to be transmitted using excitatory synapses connecting pairs of the neurons 415 of the second set 435. For example, as shown in neural network 500 of FIG. 5 (representing another example of a neural network that may be implemented using the one or more processors 230), when the first neuron 415-i (corresponding to the mobile device u₁) is activated, an excitatory signal is transmitted from the first neuron 415-i to another neuron 415 of the second set 435-i (corresponding to the user u₂) using an excitatory synapse 515-1. In turn, an excitatory signal is transmitted from the neuron 415 (corresponding to the mobile device u₂) to another neuron 415 of the second set 435-i (corresponding to another mobile device uₙ) using an excitatory synapse 515-2. The neurons 415 of a second set 435-m are connected by excitatory synapses 515-3, 515-4.

The excitatory signals potentiate the different neurons 415 included in the second set 435-i, which increases the probability of those neurons 415 of the second set 435-i becoming activated within the respective winner-take-all neuronal groups 405-1, 405-2, . . . , 405-n. As more neurons 415 of the second set 435-i are activated, more of the mobile devices are allocated to a particular edge server 210-i, which tends to reduce the number of edge servers 210 required to allocate the plurality of mobile devices and which reduces the overall energy consumption of the mobile network 200.

The neural network 500 further comprises a threshold neuron 425-m corresponding to a second set 435-m of the neurons 415. The threshold neuron 425-m comprises a plurality of inputs that are connected by first synapses 505-1, 505-2, . . . , 505-n to a respective second set of those neurons 415 of the first sets 410-1, 410-2, . . . , 410-n that correspond to a respective edge server 210-1, 210-2, . . . , 210-i, . . . 210-m of the plurality of edge servers. Each first synapse 505-1, 505-2, . . . , 505-n has a respective weight

$${w}_{1}^{k} , {w}_{2}^{k} , … , {w}_{n}^{k}$$

that corresponds to a resource requirement (of the k^{th} type) of the user u₁, u₂, . . . , uₙ corresponding to the connected neuron 415 of the second set 435-m. The threshold neuron 425-m further comprises an output that is connected by a second, inhibitory synapse 430-m to a neuron 415 of the respective second set 435-m.

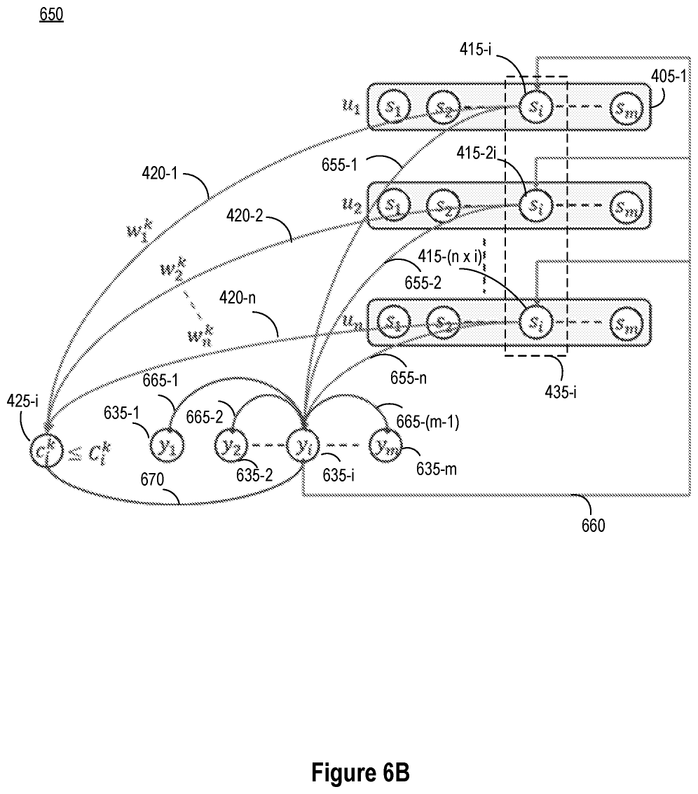

Returning to FIG. 1, at optional block 130, the electronic device 225 causes an excitatory signal to be transmitted to a first neuron of a second plurality of neurons representing which of the edge servers are selected. For example, neural network 600 of FIG. 6A (representing another example of a neural network that may be implemented using the one or more processors 230) includes a second plurality of neurons 635-1, 635-2, . . . , 635-i, . . . , 635-m corresponding to the second sets 435-1, 435-2, . . . , 435-m of the plurality of neurons 415. In some embodiments, each neuron 635 comprises a spiking neuron. The second plurality of neurons 635-1, 635-2, . . . , 635-i, . . . , 635-m are connected to neurons 415 of the winner-take-all neuronal group 405-n using excitatory synapses 645-1, . . . , 645-m. Thus, activation of a particular neuron 415 of the winner-take-all neuronal group 405-n causes an excitatory signal to be received by the connected neuron 635.

As more neurons 415 of a particular second set 435 are activated, the potentiation of the corresponding neuron 635 increases, which increases the probability of the neuron 635 becoming activated. In some embodiments, the activation of a neuron 415 causes excitatory signals to be transmitted to other neurons 415 of the second set 435 using a plurality of excitatory synapses 615-1, 615-2, 615-3.

As shown in neural network 600, the plurality of threshold neurons 625 comprises a first plurality of threshold neurons 605-1 corresponding to a resource requirement of a first resource type (i.e., k=1), and a second plurality of threshold neurons 605-d corresponding to a resource requirement of a second resource type (i.e., k=d). The neurons 415 of the winner-take-all neuronal group 405-n connect to the first plurality of threshold neurons 605-1 by a plurality of excitatory synapses 610-1, 610-2, . . . , 610-i, . . . , 610-m, and connect to the second plurality of threshold neurons 605-d by a plurality of excitatory synapses 640-1, 640-2, . . . , 640-i, . . . , 640-m.

The first plurality of threshold neurons 605-1 connect to the neurons 415 of the winner-take-all neuronal group 405-1 by a plurality of inhibitory synapses 625-1, 625-2, . . . , 625-i, . . . , 625-m. The second plurality of threshold neurons 605-d connect to the neurons 415 of the winner-take-all neuronal group 405-1 by a plurality of inhibitory synapses 630-1, 630-2, . . . , 630-i, . . . , 630-m. Thus, threshold neurons 425 of the first plurality of threshold neurons 605-1 and/or of the second plurality of threshold neurons 605-d transmit inhibitory signals to the neurons 415 of the winner-take-all neuronal group 405-1 when the respective inputs from the neurons 415 exceed the respective threshold value (less any inhibitory signals). Inhibitory feedback is then provided among the neurons 415 of the second set 435 using the inhibitory synapses 620-1, 620-2, 620-3. As discussed above, the inhibitory feedback may cause at least one of the neurons 415 of the second set 435 to deactivate, such that the capacity constraint is maintained.

At optional block 135, responsive to activation of the neuron 635 of the second plurality of neurons, the electronic device 225 causes at least one inhibitory signal to be transmitted from the neuron 635 to at least the (corresponding) threshold neuron 425 by a corresponding inhibitory synapse 650-1, . . . , 650-m. As discussed above, the threshold neuron 425 also receives excitatory signals from the “active” neurons 415 of the corresponding second set 435 by the excitatory synapse 645. By transmitting the inhibitory signal, the neuron 635 effectively increases the probability of the neuron 635 remaining activated. In some embodiments, to reduce (or minimize) the number of edge servers 210 that are selected, the neurons 635 include self-inhibitory synapses and may be referred to as self-inhibitory neurons 635. Thus, without excitatory signals (e.g., in the presence of noise alone), the self-inhibitory neurons 635 are deactivated. As neurons 415 of a second set 435 are activated, the excitatory signal(s) to the corresponding self-inhibitory neuron 635 increase the potentiation beyond the level of the self-inhibition and in some cases to activation.

When a sufficient number of the winner-take-all neuronal groups 405 (which may be any suitable predetermined value) select a particular self-inhibitory neuron 635 (i.e., through the excitatory signals provided by neurons 415 in the corresponding second set 435), the self-inhibitory neuron 635 is activated. Once activated, the self-inhibitory neuron 635 emits an inhibitory signal (which in some cases is multiplied by a weight corresponding to the capacity of the corresponding edge server 210) to the corresponding threshold neuron 425. The threshold neuron 425 determines whether the excitatory signals received from the winner-take-all neuronal groups 405 are less than the capacity.

Returning to FIG. 1, at optional block 140, responsive to activation of the first neuron of the second plurality of neurons, the electronic device 225 causes at least one inhibitory signal to be transmitted from the first neuron of the second plurality of neurons to all other neurons of the second plurality of neurons. In some embodiments, to reduce (or minimize) the number of edge servers 210 that are selected, the neurons 415 are connected by excitatory synapses to both the neurons 635 and the threshold neurons 425. For example, neural network 650 of FIG. 6B (representing another example of a neural network that may be implemented using the one or more processors 230) includes excitatory synapses 420-1, 420-1, . . . , 420-n extending from the neurons 415-i, 415-2i, . . . , 415-(n×i) of the second set 435-i to the threshold neuron 425-i, as well as excitatory synapses 655-1, 655-2, . . . , 655-n extending from the neurons 415-i, 415-2i, . . . , 415-(n×i) of the second set 435-i to the corresponding neuron 635-i. An excitatory synapse 660 extends from the neuron 635-i to the neurons 415-i, 415-2i, . . . , 415-(n×i). Inhibitory synapses 665-1, 665-2, . . . , 665-(m−1) (or “lateral inhibitory synapses”) extend from the neuron 635-i to each of the other neurons 635-1, 635-2, . . . , 635-m. An inhibitory synapse 670 extends from the threshold neuron 425-i to the neuron 635-i. Although not shown for simplicity, each of the other neurons 635-1, 635-2, . . . , 635-m may also connect to lateral inhibitory synapses, a respective inhibitory synapse 670, and a respective excitatory synapse 660.

When a sufficient number of the winner-take-all neuronal groups 405 (the number may be any suitable predetermined value) select the neuron 635-i (i.e., through the excitatory signals provided on the excitatory synapses 655-1, 655-2, . . . , 655-n), the neuron 635-i is activated. Once activated, the neuron 635-i emits inhibitory signals on the inhibitory synapses 665-1, 665-2, . . . , 665-(m−1) to each of the other neurons 635-1, 635-2, . . . , 635-m, and emits an excitatory signal on the excitatory synapse 660 to the neurons 415-i, 415-2i, . . . , 415-(n×i).

By emitting the inhibitory signals on the inhibitory synapses 665-1, 665-2, . . . , 665-(m−1) and emitting the excitatory signal on the excitatory synapse 660, the neuron 635-i increases the probability that other ones of the winner-take-all neuronal groups 405 will also select the neurons 415-i, 415-2i, . . . , 415-(n×i) of the second set 435-i and associated with the neuron 635-i. In this way, the mobile devices can be preferentially allocated to the edge server 210-i associated with the second set 435-i when the neuron 635-i is activated. The preferential allocation is further encouraged as the neurons 415, representing connections to other edge servers 210, do not receive excitatory signals from the corresponding neurons 635 (as these neurons 635 have been inhibited by the inhibitory signals received on the inhibitory synapses 665-1, 665-2, . . . , 665-(m−1)). Thus, the first neuron 635 to activate is advantaged relative to the other neurons 635.

Each of the threshold neurons 425 has a relatively higher threshold for activation, and the threshold neuron 425-i activates when the capacity constraint for that particular edge server 210-i has been reached. In turn, the threshold neuron 425-i when activated inhibits the neuron 635-i for the corresponding edge server 210-i. Inhibiting the neuron 635-i causes the allocation of mobile devices to the corresponding edge server 210-i to stop, as well as stopping the inhibitory signals emitted to the other neurons 635. This permits another neuron 635 to activate and to have mobile devices preferentially allocated to the corresponding (second) edge server 210. Notably, the excitation of the other neuron 635 is not strong enough to activate the neurons 415 of winner-take-all neuronal groups 405 that already have neurons 415 activated (representing connections to the first edge server).

Returning to FIG. 1, at block 145, the electronic device 225 causes, responsive to activating the first neuron 415, an excitatory signal to be transmitted on a first synapse at a first threshold neuron of a plurality of threshold neurons. Returning to the example of FIG. 4, a plurality of excitatory synapses 420-1, 420-2, . . . , 420-n corresponding to the winner-take-all neuronal groups 405-1, 405-2, . . . , 405-n (or to the first sets 410-1, 410-2, . . . , 410-n) are connected to the threshold neuron 425-i (depicted as

$${c}_{i}^{k}$$

corresponding to the edge server 210-i with a resource type k∈{1, . . . , d}. Each first synapse 420-1, 420-2, . . . , 420-n has a respective weight

$${w}_{1}^{k} , {w}_{2}^{k} , … , {w}_{n}^{k}$$

that corresponds to a resource requirement (of the k^{th} type) of the mobile device u₁, u₂, . . . , uₙ corresponding to the activated neuron 415 of the second set 435.

At block 150, responsive to the excitatory signal causing the first threshold neuron 425-i to activate, the electronic device 225 causes at least one inhibitory signal to be transmitted from the first threshold neuron 425-i to at least one other neuron 415 of the respective second set 435-i. The threshold neuron 425-i has a threshold value

$${C}_{i}^{k}$$

corresponding to the k^{th} resource capacity of the edge server 210-i. When the cumulative input from the neurons 415 exceeds the threshold

$${C}_{i}^{k} ,$$

the threshold neuron 423-i is activated and transmits inhibitory feedback to at least the activated server neuron(s) 415 of the second set 435-i.

In some embodiments, and as shown in the neural network 400, a plurality of inhibitory synapses 430-1, 430-2, . . . , 430-n connect the threshold neuron 425-i to the neurons 415 of the second set 435-i. The inhibitory signals deactivate one or more of the activated neurons 415, which in turn deactivates (or reduces) one or more of the excitatory signals transmitted on the plurality of excitatory synapses 420-1, 420-2, . . . , 420-n. The decreased excitation causes the cumulative input from the neurons 415 to no longer exceed the threshold Cᵢ^{k}, such that the capacity constraint is maintained.

In some embodiments, causing at least one inhibitory signal to be transmitted from the first threshold neuron 425-i to at least one other neuron 415 of the respective second set 435-i comprises causing a single inhibitory signal to be transmitted to a neuron 415 of the second set 435-i. For example, as shown in the neural network 500, the electronic device 225 transmits a single inhibitory signal to a neuron 415 of the second set 435-i in the winner-take-all neuronal group 405-n. The electronic device 225 causes inhibitory signals to be transmitted from the neuron 415 to other neurons 415 of the second set 435-i using inhibitory synapses 510-1, 510-2 connecting pairs of the neurons 415 of the second set 435-i. Alternate embodiments may have multiple inhibitory signals transmitted from the first threshold neuron 425-i to the neurons 415, while excitatory synapses 515-1, 515-2, 515-3, 515-4 connect pairs of neurons 415 of the respective second set 435. The method 100 ends following completion of block 145.

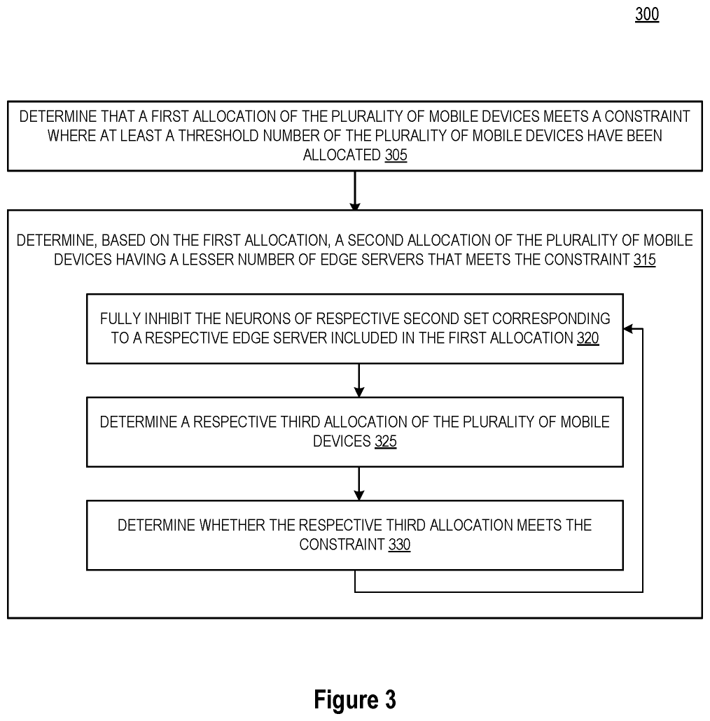

Next, FIG. 3 illustrates a method 300 of determining an edge user allocation having a minimal number of edge servers, according to one or more embodiments. The method 300 may be used in conjunction with other embodiments. For example, some or all of the method 100 of

FIG. 1 may be performed (in one or more instances) by the electronic device 225 in conjunction with the method 300.

The method 300 begins at block 305, where the electronic device 225 determines that a first allocation of the plurality of mobile devices meets a constraint where at least a threshold number of the plurality of mobile devices have been allocated. In some embodiments, the electronic device 225 determines the first allocation as a result of performing the method 100. The first allocation may provide an approximate solution to the objective function discussed above according to the constraints.

In some embodiments, the threshold number is selected to correspond to all of the mobile devices connected to the mobile network 200 (e.g., all mobile devices 220 within the coverage area associated with at least one of the edge servers 210). In some embodiments, the threshold number is less than all of the mobile devices of the mobile network 200. For example, the electronic device 225 may determine a maximum number of mobile devices supported.

At block 315, the electronic device 225 determines, based on the first allocation, a second allocation of the plurality of mobile devices having a lesser number of edge servers that meets the constraint. In some embodiments, determining the second allocation comprises, at block 320, fully inhibiting the neurons corresponding to a respective set corresponding to a respective edge server included in the first allocation. In this way, the particular edge server would be removed from consideration for a subsequent determination of a user allocation. At block 325, the electronic device 225 determines a respective third allocation of the plurality of mobile devices. For example, the method 100 may be performed at block 325 with the particular edge server selected in block 320 removed from consideration. At block 330, the electronic device 225 determines whether the third allocation meets the constraint.

The blocks 320, 325, 330 may be performed in one or more instances within block 315. For example, if the third allocation does not meet the constraint in a first instance of performing block 330, the third allocation may be discarded. However, if the third allocation meets the constraint, the method 300 may proceed from block 330 to block 320 where the neurons of another edge server are fully inhibited. In such cases, the second allocation may be determined as the last third allocation that meets the constraint. The method 300 ends following completion of the block 315.

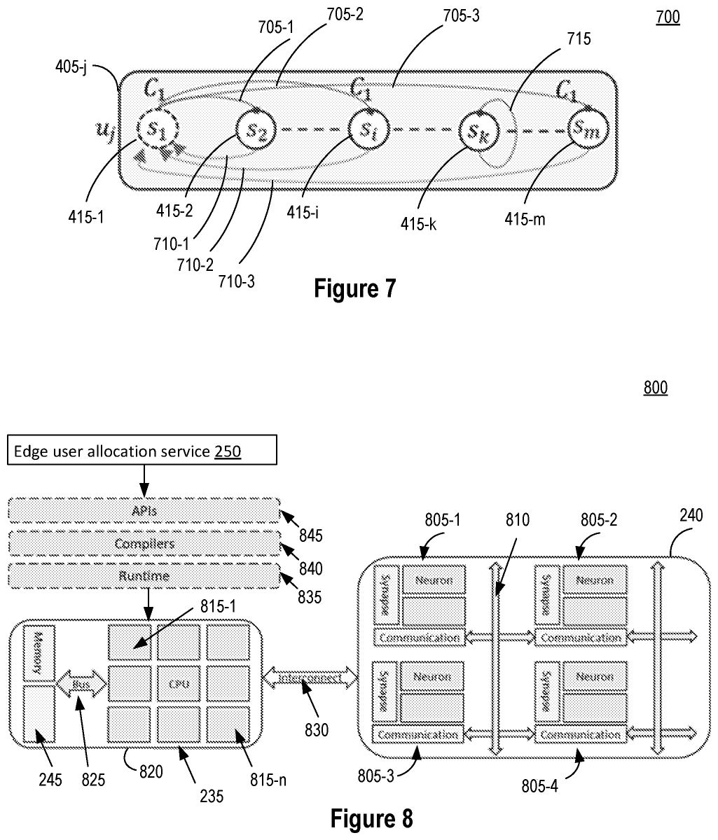

Next, FIG. 7 is a diagram 700 illustrating inhibitory synapses from a server neuron having a greater resource capacity than other server neurons of a first set, according to one or more embodiments. The features depicted in the diagram 700 may be used in conjunction with other embodiments, such as part of the winner-take-all neuronal groups 405 of the neural networks 400, 500, 600.

In the diagram 700, the winner-take-all neuronal group 405-j corresponding to a user uⱼ and comprising a plurality of neurons 415-1, 415-2, . . . , 415-i, . . . , 415-k, . . . , 415-m. The neuron 415-k has a self-inhibitory synapse 715, e.g., when the user uⱼ is determined to be outside the coverage area of the edge server 210 associated with the neuron 415-k.

As discussed above, for energy efficiency of the mobile network 200, the electronic device 225 may select a minimal number of edge servers 210 to be operated to support the connected mobile devices and/or may maximize the utilization of the operating edge servers 210. Within the winner-take-all neuronal group 405-j, the activation of one of the neurons 415 corresponds to deactivation of the remaining neurons 415. Alternate approaches may include an auxiliary neuron that performs the deactivation function using inhibitory synapses connected to the neurons 415.

In some embodiments, one neuron 415-1 of the winner-take-all neuronal group 405-j is determined as having a greater resource capacity than the other neurons 415-2, . . . , 415-m. An inhibitory synapse 705-1 extends from the neuron 415-1 to the neuron 415-2, an inhibitory synapse 705-2 extends from the neuron 415-1 to the neuron 415-i, and an inhibitory synapse 705-3 extends from the neuron 415-1 to the neuron 415-m. In some embodiments, each of the inhibitory synapses 705-1, 705-2, 705-3 has a synaptic weight C₁ corresponding to the capacity of the neuron 415-1.

In some embodiments, an excitatory synapse 710-1 extends from the neuron 415-2 to the neuron 415-1, an excitatory synapse 710-2 extends from the neuron 415-i to the neuron 415-1, and an excitatory synapse 710-3 extends from the neuron 415-m to the neuron 415-1. In this way, activation of any of the other neurons 415-2, . . . , 425-m causes an excitatory signal to be transmitted to the neuron 415-1, which potentiates the neuron 415-1 and increases the probability that the neuron 415-1 will be activated. In this way, the winner-take-all neuronal group 405-j prefers activation of the neuron 415-1 having the greater resource capacity. This tends to fill the resource capacity of larger edge servers 210 first, which maximizes the utilization and/or minimizes the total number of edge servers 210.

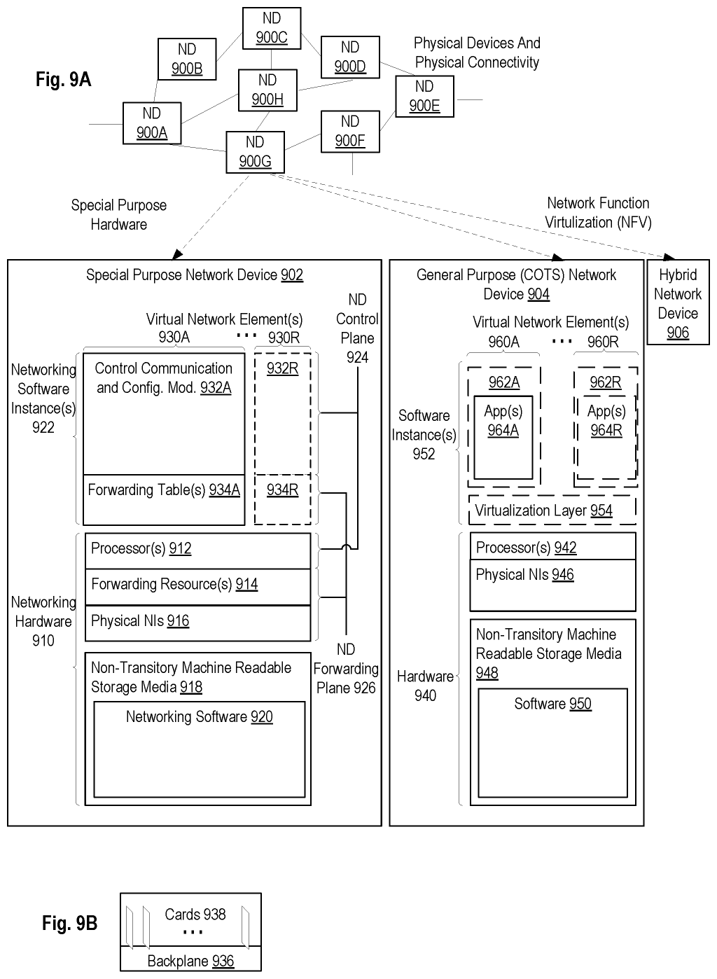

FIG. 8 is a diagram 800 illustrating exemplary neuromorphic hardware 240, according to one or more embodiments. The features illustrated in the diagram 800 may be used in conjunction with other embodiments. For example, the diagram 800 may represent an exemplary architecture of the electronic device 225 of FIG. 2.

In the diagram 800, the neuromorphic hardware 240 comprises a plurality of neuromorphic cores 805-1, . . . 805-4. Although four (4) neuromorphic cores 805 are depicted, any alternate number of neuromorphic cores 805 are also contemplated (e.g., hundreds or thousands of cores, or more). Each neuromorphic core 805 comprises a plurality of neurons, a plurality of synapses, and a communication interface. The communication interfaces of the neuromorphic cores 805-1, . . . 805-4 are interconnected with each other using buses 810.

The host CPU 235 and the machine-readable media 245 are included in a host printed circuit board assembly (PCBA) 820. As shown, the host PCBA 820 is shown as separate from the neuromorphic hardware 240 and connected using an interconnect 830 having any suitable implementation, such as Peripheral Component Interface Express (PCIe), Ethernet, and so forth. The host CPU 235 comprises a plurality of processor cores 815-1, . . . , 815-n that are connected to the machine-readable media 245 using a bus 825 having any suitable implementation.

In some embodiments, the host CPU 235 executes computer code including the edge user allocation service 250 to perform various functionality described herein. In some embodiments, the edge user allocation service 250 uses application programming interfaces (APIs) 845 and compilers 840 to program a spiking neural network architecture onto the neuromorphic hardware 240, e.g., according to the edge user allocations determined by the edge user allocation service 250. In some embodiments, the host CPU 235 also executes computer coder including a runtime 835 that provides low-level and system-level management functions.

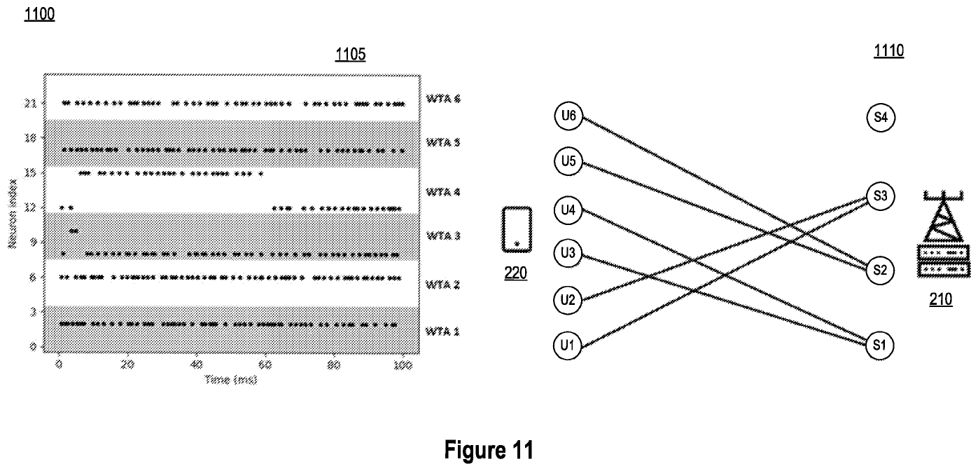

Refer now to FIG. 11, where diagram 1100 illustrates application of the neural network-based implementations to an example allocation scenario, where six (6) mobile devices 220 (labeled as U1, U2, . . . , U6) are allocated to four (4) edge servers 210 (labeled as S1, S2, . . . , S4) each having a capacity of three (3) units. After tuning, the neural network-based implementations effectively maximize the number of the mobile devices 220 allocated to the edge servers 210 while satisfying all of the relevant constraints. For example, in a trial of 100 tests, the neural network-based implementations always satisfied all the constraints, and returned sub-optimal results for 93% of the tests. Due to the stochastic nature of the neural network-based implementations, there is a non-trivial probability (here, 7% of the tests) to yield an optimal allocation.

The diagram 1105 illustrates a raster plot of the convergence to a stable solution using the neural network-based implementations. Each of the mobile devices 220 is represented as a respective winner-take-all neuronal group (labeled as WTA 1, WTA 2, . . . , WTA 6). Each dot represents a spike from a neuron within the particular winner-take-all neuronal group 405. The neurons with index values 0, 4, 8, 12, 16, and 20 represent connections to a first edge server 210 (S1). The neurons with index values 1, 5, 9, 13, 17, and 21 represent connections to a second edge server 210 (S2), and so on. Each neuron that continuously spikes is considered activated, and those neurons which are active at the end of the time (here, about 100 milliseconds (ms)) represent the output of the neural network-based implementations. In this iteration, a stable solution is found in about 60 ms. At that point, the neural network-based implementation switches from four (4) active edge servers 210 to three (3) active servers. The diagram 1110 illustrates the resulting connections between the mobile devices 220 and the edge 210 servers according to the stable solution.

Refer now to FIG. 9A, which illustrates connectivity between network devices (NDs) within an exemplary network, as well as three exemplary implementations of the NDs, according to some embodiments of the invention. As used herein, a network device is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 9A shows NDs 900A-H, and their connectivity by way of lines between 900A-900B, 900B-900C, 900C-900D, 900D-900E, 900E-900F, 900F-900G, and 900A-900G, as well as between 900H and each of 900A, 900C, 900D, and 900G. These NDs are physical devices, and the connectivity between these NDs can be wireless or wired (often referred to as a link). An additional line extending from NDs 900A, 900E, and 900F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application-specific integrated-circuits (ASICs) and a special-purpose operating system (OS); and 2) a general-purpose network device 904 that uses common off-the-shelf (COTS) processors and a standard OS.

The special-purpose network device 902 includes networking hardware 910 comprising a set of one or more processor(s) 912, forwarding resource(s) 914 (which typically include one or more ASICs and/or network processors), and physical network interfaces (NIs) 916 (through which network connections are made, such as those shown by the connectivity between NDs 900A-H), as well as non-transitory machine readable storage media 918 having stored therein networking software 920. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

The special-purpose network device 902 is often physically and/or logically considered to include: 1) a ND control plane 924 (sometimes referred to as a control plane) comprising the processor(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the processor(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general-purpose network device 904 includes hardware 940 comprising a set of one or more processor(s) 942 (which are often COTS processors) and physical NIs 946, as well as non-transitory machine-readable storage media 948 having stored therein software 950. During operation, the processor(s) 942 execute the software 950 to instantiate one or more sets of one or more applications 964A-R. While one embodiment does not implement virtualization, alternative embodiments may use different forms of virtualization. For example, in one such alternative embodiment the virtualization layer 954 represents the kernel of an operating system (or a shim executing on a base operating system) that allows for the creation of multiple instances 962A-R called software containers that may each be used to execute one (or more) of the sets of applications 964A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 954 represents a hypervisor (sometimes referred to as a virtual machine monitor (VMM)) or a hypervisor executing on top of a host operating system, and each of the sets of applications 964A-R is run on top of a guest operating system within an instance 962A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels and sets of applications that are run in different software containers).

The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual network element(s) 960A-R.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 962A-R to VNEs also apply to embodiments where such a finer level of granularity and/or unikernels are used.

In certain embodiments, the virtualization layer 954 includes a virtual switch that provides similar forwarding services as a physical Ethernet switch. Specifically, this virtual switch forwards traffic between instances 962A-R and the physical NI(s) 946, as well as optionally between the instances 962A-R; in addition, this virtual switch may enforce network isolation between the VNEs 960A-R that by policy are not permitted to communicate with each other (e.g., by honoring virtual local area networks (VLANs)).

The third exemplary ND implementation in FIG. 9A is a hybrid network device 906, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 9C illustrates various exemplary ways in which VNEs may be coupled according to some embodiments of the invention. FIG. 9C shows VNEs 970A.1-970A.P (and optionally VNEs 970A.Q-970A.R) implemented in ND 900A and VNE 970H.1 in ND 900H. In FIG. 9C, VNEs 970A.1-P are separate from each other in the sense that they can receive packets from outside ND 900A and forward packets outside of ND 900A; VNE 970A.1 is coupled with VNE 970H.1, and thus they communicate packets between their respective NDs; VNE 970A.2-970A.3 may optionally forward packets between themselves without forwarding them outside of the ND 900A; and VNE 970A.P may optionally be the first in a chain of VNEs that includes VNE 970A.Q followed by VNE 970A.R (this is sometimes referred to as dynamic service chaining, where each of the VNEs in the series of VNEs provides a different service—e.g., one or more layer 4-7 network services). While FIG. 9C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 9A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 9A may also host one or more such servers (e.g., in the case of the general purpose network device 904, one or more of the software instances 962A-R may operate as servers; the same would be true for the hybrid network device 906; in the case of the special-purpose network device 902, one or more such servers could also be run on a virtualization layer executed by the processor(s) 912); in which case the servers are said to be co-located with the VNEs of that ND.

A virtual network is a logical abstraction of a physical network (such as that in FIG. 9A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 9D illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention. Specifically, FIG. 9D illustrates network elements (NEs) 970A-H with the same connectivity as the NDs 900A-H of FIG. 9A.

FIG. 9D illustrates that the distributed approach 972 distributes responsibility for generating the reachability and forwarding information across the NEs 970A-H; in other words, the process of neighbor discovery and topology discovery is distributed.

For example, where the special-purpose network device 902 is used, the control communication and configuration module(s) 932A-R of the ND control plane 924 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 970A-H (e.g., the processor(s) 912 executing the control communication and configuration module(s) 932A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 924. The ND control plane 924 programs the ND forwarding plane 926 with information (e.g., adjacency and route information) based on the routing structure(s). For example, the ND control plane 924 programs the adjacency and route information into one or more forwarding table(s) 934A-R (e.g., Forwarding Information Base (FIB), Label Forwarding Information Base (LFIB), and one or more adjacency structures) on the ND forwarding plane 926. For layer 2 forwarding, the ND can store one or more bridging tables that are used to forward data based on the layer 2 information in that data. While the above example uses the special-purpose network device 902, the same distributed approach 972 can be implemented on the general purpose network device 904 and the hybrid network device 906.

FIG. 9D illustrates that a centralized approach 974 (also known as software defined networking (SDN)) that decouples the system that makes decisions about where traffic is sent from the underlying systems that forwards traffic to the selected destination. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the processor(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

While the above example uses the special-purpose network device 902, the same centralized approach 974 can be implemented with the general purpose network device 904 (e.g., each of the VNE 960A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 960A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general-purpose network device 904 or hybrid network device 906 implementations as NFV is able to support SDN by providing an infrastructure upon which the SDN software can be run, and NFV and SDN both aim to make use of commodity server hardware and physical switches.

FIG. 9D also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 9D shows the distributed approach 972 separate from the centralized approach 974, the effort of network control may be distributed differently or the two combined in certain embodiments of the invention. For example: 1) embodiments may generally use the centralized approach (SDN) 974, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 974, but may also be considered a hybrid approach.

While FIG. 9D illustrates the simple case where each of the NDs 900A-H implements a single NE 970A-H, it should be understood that the network control approaches described with reference to FIG. 9D also work for networks where one or more of the NDs 900A-H implement multiple VNEs (e.g., VNEs 930A-R, VNEs 960A-R, those in the hybrid network device 906). Alternatively or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

On the other hand, FIGS. 9E and 9F respectively illustrate exemplary abstractions of NEs and VNEs that the network controller 978 may present as part of different ones of the virtual networks 992. FIG. 9E illustrates the simple case of where each of the NDs 900A-H implements a single NE 970A-H (see FIG. 9D), but the centralized control plane 976 has abstracted multiple of the NEs in different NDs (the NEs 970A-C and G-H) into (to represent) a single NE 970I in one of the virtual network(s) 992 of FIG. 9D, according to some embodiments of the invention. FIG. 9E shows that in this virtual network, the NE 970I is coupled to NE 970D and 970F, which are both still coupled to NE 970E.

FIG. 9F illustrates a case where multiple VNEs (VNE 970A.1 and VNE 970H.1) are implemented on different NDs (ND 900A and ND 900H) and are coupled to each other, and where the centralized control plane 976 has abstracted these multiple VNEs such that they appear as a single VNE 970T within one of the virtual networks 992 of FIG. 9D, according to some embodiments of the invention. Thus, the abstraction of a NE or VNE can span multiple NDs.

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 10 illustrates, a general-purpose control plane device 1004 including hardware 1040 comprising a set of one or more processor(s) 1042 (which are often COTS processors) and physical NIs 1046, as well as non-transitory machine-readable storage media 1048 having stored therein centralized control plane (CCP) software 1050.

In embodiments that use compute virtualization, the processor(s) 1042 typically execute software to instantiate a virtualization layer 1054 (e.g., in one embodiment the virtualization layer 1054 represents the kernel of an operating system (or a shim executing on a base operating system) that allows for the creation of multiple instances 1062A-R called software containers (representing separate user spaces and also called virtualization engines, virtual private servers, or jails) that may each be used to execute a set of one or more applications; in another embodiment the virtualization layer 1054 represents a hypervisor (sometimes referred to as a virtual machine monitor (VMM)) or a hypervisor executing on top of a host operating system, and an application is run on top of a guest operating system within an instance 1062A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1040, directly on a hypervisor represented by virtualization layer 1054 (in which case the unikernel is sometimes described as running within a LibOS virtual machine), or in a software container represented by one of instances 1062A-R). Again, in embodiments where compute virtualization is used, during operation an instance of the CCP software 1050 (illustrated as CCP instance 1076A) is executed (e.g., within the instance 1062A) on the virtualization layer 1054. In embodiments where compute virtualization is not used, the CCP instance 1076A is executed, as a unikernel or on top of a host operating system, on the “bare metal” general purpose control plane device 1004. The instantiation of the CCP instance 1076A, as well as the virtualization layer 1054 and instances 1062A-R if implemented, are collectively referred to as software instance(s) 1052.

In some embodiments, the CCP instance 1076A includes a network controller instance 1078. The network controller instance 1078 includes a centralized reachability and forwarding information module instance 1079 (which is a middleware layer providing the context of the network controller 978 to the operating system and communicating with the various NEs), and an CCP application layer 1080 (sometimes referred to as an application layer) over the middleware layer (providing the intelligence required for various network operations such as protocols, network situational awareness, and user—interfaces). At a more abstract level, this CCP application layer 1080 within the centralized control plane 976 works with virtual network view(s) (logical view(s) of the network) and the middleware layer provides the conversion from the virtual networks to the physical view.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities-for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used-for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VOD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method, performed by an electronic device, for performing edge user allocation for a plurality of mobile devices connected to a mobile network, the method comprising:
selecting a first edge server of a plurality of edge servers of the mobile network to connect with a first mobile device of the plurality of mobile devices, selecting the first edge server causing a first neuron of a plurality of neurons to be activated, the plurality of neurons arranged as a plurality of winner-take-all neuronal groups, each winner-take-all neuronal group corresponding to a respective mobile device of the plurality of mobile devices and comprising a respective first set of the plurality of neurons that represents the plurality of edge servers, the first neuron representing the first edge server in the first set;
causing, responsive to the first neuron being activated, an excitatory signal to be transmitted on a first synapse to a first threshold neuron of a plurality of threshold neurons, each threshold neuron comprising a plurality of inputs connected by respective first synapses to a respective second set of those neurons of the first set that correspond to a respective edge server of the plurality of edge servers, each first synapse having a respective weight
$$( {w}_{1}^{k} , {w}_{2}^{k} , … , {w}_{n}^{k} )$$
corresponding to a resource requirement of the mobile device corresponding to a connected neuron of the second set; and
responsive to the excitatory signal causing the first threshold neuron to activate, causing at least one inhibitory signal to be transmitted from the first threshold neuron to at least one other neuron of the second set.

2. The method of claim 1, wherein causing at least one inhibitory signal to be transmitted comprises causing a plurality of inhibitory signals to be transmitted to a plurality of neurons of the second set.

3. The method of claim 1, further comprising:
causing, responsive to the first neuron being activated, excitatory signals to be transmitted using excitatory synapses connecting pairs of neurons of the second set.

4. The method of claim 1, wherein the plurality of threshold neurons comprises:
a first plurality of threshold neurons corresponding to a resource requirement of a first resource type; and
a second plurality of threshold neurons corresponding to a resource requirement of a second resource type.

5. The method of claim 1, further comprising:
determining that a location of the first mobile device is outside a coverage area associated with a second edge server of the plurality of edge servers; and
causing, using a self-inhibitory synapse, an inhibitory signal to be transmitted to a second neuron representing the second edge server in the first set.

6. The method of claim 1, further comprising:
causing, responsive to the first neuron being activated, an excitatory signal to be transmitted to a first, self-inhibitory neuron of a second plurality of neurons representing which of the plurality of edge servers are selected; and
responsive to activation of the first, self-inhibitory neuron of the second plurality of neurons, causing at least one inhibitory signal to be transmitted from the first neuron of the second plurality of neurons to at least the first threshold neuron.

7. The method of claim 1, further comprising:
causing, responsive to the first neuron being activated, an excitatory signal to be transmitted to a first neuron of a second plurality of neurons representing which of the plurality of edge servers are selected; and
responsive to activation of the first neuron of the second plurality of neurons, causing at least one inhibitory signal to be transmitted from the first neuron of the second plurality of neurons to all other neurons of the second plurality of neurons.

8. The method of claim 1, wherein for at least a first winner-take-all neuronal group, at least a first neuron of the respective first set, representing a first edge server having a greater resource capacity than other edge servers represented by other neurons of the first set, connects to the other neurons by one or more inhibitory synapses.

9. The method of claim 1, further comprising:
determining, responsive to selecting the first edge server, that a first allocation of the plurality of mobile devices meets a constraint where at least a threshold number of the plurality of mobile devices have been allocated; and
determining, based on the first allocation, a second allocation of the plurality of mobile devices having a lesser number of edge servers that meets the constraint, wherein determining the second allocation comprises, for each of one or more instances:
fully inhibiting neurons of a respective second set corresponding to a respective edge server included in the first allocation; and
determining whether a respective third allocation of the plurality of mobile devices, determined responsive to fully inhibiting the neurons, meets the constraint.

10. A non-transitory machine-readable storage medium comprising computer program code which when executed by a computer performs edge user allocation for a plurality of mobile devices connected to a mobile network by performing operations comprising:
selecting a first edge server of a plurality of edge servers of the mobile network to connect with a first mobile device of the plurality of mobile devices, selecting the first edge server causing a first neuron of a plurality of neurons to be activated, the plurality of neurons arranged as a plurality of winner-take-all neuronal groups, each winner-take-all neuronal group corresponding to a respective mobile device of the plurality of mobile devices and comprising a respective first set of the plurality of neurons that represents the plurality of edge servers, the first neuron representing the first edge server in the first set;
causing, responsive to the first neuron being activated, an excitatory signal to be transmitted on a first synapse to a first threshold neuron of a plurality of threshold neurons, each threshold neuron comprising a plurality of inputs connected by respective first synapses to a respective second set of those neurons of the first set that correspond to a respective edge server of the plurality of edge servers, each first synapse having a respective weight
$$( {w}_{1}^{k} , {w}_{2}^{k} , … , {w}_{n}^{k} )$$
corresponding to a resource requirement of the mobile device corresponding to a connected neuron of the second set; and
responsive to the excitatory signal causing the first threshold neuron to activate, causing at least one inhibitory signal to be transmitted from the first threshold neuron to at least one other neuron of the second set.

11. An electronic device comprising:
a machine-readable medium comprising computer program code for an edge user allocation service to perform edge user allocation for a plurality of mobile devices connected to a mobile network; and
one or more processors to execute the edge user allocation service to cause the electronic device to implement:
a plurality of neurons arranged as a plurality of winner-take-all neuronal groups, each winner-take-all neuronal group corresponding to a respective mobile device of the plurality of mobile devices, and comprising a respective first set of the plurality of neurons that represents a plurality of edge servers of the mobile network; and
a plurality of threshold neurons, each threshold neuron comprising:
a plurality of inputs connected by first synapses to a respective second set of those neurons of the first set that correspond to a respective edge server of the plurality of edge servers, each first synapse having a respective weight
$$( {w}_{1}^{k} , {w}_{2}^{k} , … , {w}_{n}^{k} )$$
corresponding to a resource requirement of the mobile device corresponding to a connected neuron of the second set; and
one or more outputs connected by one or more second, inhibitory synapses to one or more neurons of the second set.

12. The electronic device of claim 11, wherein the one or more outputs comprising a plurality of outputs, and the one or more second, inhibitory synapses comprising a plurality of second, inhibitory synapses connecting the plurality of outputs to all of the neurons of the second set.

13. The electronic device of claim 11, further comprising:
one or more third, excitatory synapses that connect pairs of neurons of the second set, and
the one or more third, excitatory synapses to communicate excitatory signals to the neurons of the second set responsive to activation of one or more of the neurons of the second set.

14. The electronic device of claim 11, wherein the plurality of threshold neurons comprises:
a first plurality of threshold neurons corresponding to a resource requirement of a first resource type; and
a second plurality of threshold neurons corresponding to a resource requirement of a second resource type.

15. The electronic device of claim 11, wherein for at least a first winner-take-all neuronal group corresponding to a first mobile device, at least a first neuron of the first set includes a self-inhibitory synapse, indicating that the first mobile device is outside a coverage area associated with an edge server corresponding to the first neuron.

16. The electronic device of claim 11, further comprising:
a second plurality of neurons representing which of the plurality of edge servers are selected, the second plurality of neurons connected:
to the second set by a plurality of fourth, excitatory synapses; and
to the plurality of threshold neurons by a plurality of fifth, inhibitory synapses.

17. The electronic device of claim 16, wherein the second plurality of neurons include self-inhibitory synapses.

18. The electronic device of claim 16, wherein each of the second plurality of neurons is connected to other ones of the second plurality of neurons by a plurality of sixth, inhibitory synapses.

19. The electronic device of claim 11, wherein for at least a first winner-take-all neuronal group, at least a first neuron of the respective first set, representing a first edge server having a greater resource capacity than other edge servers represented by other neurons of the first set, connects to the other neurons by one or more inhibitory synapses.

20. The electronic device of claim 11, wherein the one or more processors comprise neuromorphic hardware that the edge user allocation service configures to cause the electronic device to implement at least the plurality of neurons, the plurality of threshold neurons, the first synapses, and the one or more second, inhibitory synapses.
